(19) United States
(12) Patent Application Publication
(10) Pub. No.: US 2015/0190302 A1
(43) Pub. Date: Jul. 9, 2015

(54) CELLULITE APPEARANCE REDUCTION APPARATUS AND METHOD

(71) Applicant: Paul 's Engineering, Inc., West Bloomfield, MI (US)

(72) Inventor: Paul J. Roubal, West Bloomfield, MI (US)

(21) Appl. No.: 14/627,417

(22) Filed: Feb. 20, 2015

Related U.S. Application Data
(62) Division of application No. 13/476,404, filed on May 21, 2012.
(60) Provisional application No. 61/489,890, filed on May 25, 2011.

(51) Int. Cl. A61H 11/02

(52) U.S. Cl. CPC A61H 11/02; A61H 2207/00; A61H 2201/169

(57) ABSTRACT

The invention includes devices and methods for reducing the appearance of cellulite in human skin. The device includes a belt having a tactile gripping portion for removably adhering to skin. When the belt is connected to a reciprocating vibratory massage device, the tactile belt grips the skin preventing substantial relative movement between the belt and the skin. On continued reciprocal movement of the belt through a stroke length and at a frequency, the outer layers of the skin are forcibly moved relative to the subcutaneous tissue layers thereby disrupting, stretching and/or tearing fat/collagen projections extending from the subcutaneous tissue into the outer skin layers thereby reducing the appearance of cellulite in the skin.

### CROSS-REFERENCE TO RELATED-APPLICATION

This divisional application claims priority benefit to U.S. Utility application Ser. No. 13/476,404 filed May 21, 2012 which claims priority benefit to U.S. Provisional Patent Application No. 61/489,890 filed May 25, 2011 the entire contents of both application are incorporated herein by reference.

### FIELD OF INVENTION

The present invention generally pertains to devices and methods for reducing the appearance of cellulite in humans.

### BACKGROUND OF THE INVENTION

Humans, and especially aging individuals, are increasingly sensitive with physical appearances. Almost all female individuals, to various degrees, develop bumpy, fatty tissue deposits in the subcutaneous tissue layers deep under the skin which extend or project into the skin. These uneven and irregular fat cell/collagen projections from the subcutaneous tissue layers into the skin manifest in an undesirable dimpled or bumpy appearance to the skin which is generally called cellulite. Various devices and procedures have been proposed to reduce or eliminate this cellulite appearance or skin condition. The proposed devices and treatments include laser, topical creams, injections of homeopathic extracts, vitamins, vacuum rolling, radio waves, massage, subcision surgery, silicone injection, liposuction and skin kneading. These prior devices or procedures suffer from one or more disadvantages of either not being effective, require expensive equipment, or require administration by medical professionals in multiple procedures often costing tens of thousands of dollars.

It would be advantageous to develop a device and method which reduces or eliminates the cellulite appearance or skin condition generated in the subcutaneous tissue layers beneath the outer skin. It would be further advantageous if the devices and methods were able to be used and executed without the need for invasive medical procedures; expensive medical facilities, equipment or treatment or direct observation by medical professionals. It would further be advantageous for the devices and methods to be compatible with conventional exercise equipment, be relatively inexpensive and used by individuals in the comfort of their own homes.

### SUMMARY OF INVENTION

The present invention includes devices and methods for reducing the appearance of cellulite in human skin. In one example of the inventive device, an elongate belt is provided having connectors adjacent opposing ends. The connectors are adapted for engagement with a conventional vibratory massage device. The belt includes a grip portion which is positioned to cover at least a center portion of the belt between the opposing ends. The grip portion of the belt includes a contact surface used to directly contact with the skin of a user, for example the thigh of a person. When connected to the reciprocating massage device, the grip portion tactilely grips the skin resisting relative motion between the belt and the skin while creating relative movement between the adhered outer skin layers relative to the subcutaneous tissue layers. The devices and processes have been shown to be effective in reducing the appearance of cellulite in the area of use.

In other examples of the device, the belt includes grip portions on both sides of the belt and end connectors which are adaptable for alternating use of both sides of the belt for increased durability and possibly different grip portions on opposing sides of the belt.

In another example, the belt grip portion wraps around the upper and lower edges of the belt.

In an example of a method for reducing cellulite appearance in skin, a belt having a gripping portion is positioned partially around a user in an area where the appearance of cellulite is present. A tactile contact surface of the gripping portion is placed against the skin removably adhering the belt to the skin. In one example, the belt is connected to a reciprocating or vibratory message machine which is activated. While the belt is moved in a back and forth fashion at a frequency, the tactile belt contact surface grips the adhered skin and rapidly moves the outer layers of the skin relative to the subcutaneous tissue layers thereby disrupting, stretching, tearing or severing the fat cell/collagen projections extending into the outer skin layers reducing the cellulite appearance which is highly desired by women.

In a method of forming a belt for use in reducing the appearance of cellulite, an elongate belt is formed with a gripping portion having a tactile contact surface which is removably connected to the skin as described above. Connectors are attached to the belt for aiding reciprocal movement of the belt in a manner described above, for example a reciprocal vibratory massage device.

Other examples of devices and methods of the present invention are illustrated and described below, as well as similar devices and methods known by those skilled in the art, are within the scope of the present invention.

### BRIEF DESCRIPTION OF THE DRAWING

The description herein makes reference to the accompanying drawings wherein like reference numerals refer like parts throughout the several views and wherein:

FIG. 1 is a schematic view of an example of the inventive cellulite reduction belt in an exemplary method with an exemplary commercial vibratory massage device.

FIG. 2 is a side elevational view of an example of a belt assembly shown in FIG. 1;

FIG. 3 is a fragmentary top view of one end of the belt assembly of FIG. 2 illustrating an example of an end connector;

FIG. 4 is a enlarged fragmentary top view of the belt assembly of FIG. 3 illustrating a gripping portion on one side of the belt;

FIG. 5 is an enlarged cross-sectional view of the belt shown in FIG. 4 in an exemplary use in direct contact with the skin of a user;

FIG. 6 is an enlarged view taken within the circle 6 of FIG. 5;

FIG. 7 is a perspective view of the belt assembly shown in FIG. 1 with an exemplary end connector for use in an exemplary method;

FIG. 8 is an alternate perspective view of the belt shown in FIG. 7 without the universal connector;

FIG. 9 is a perspective view of the exemplary connector shown in FIG. 7;

FIG. 10 is an enlarged cross-sectional view of an alternate belt shown in FIG. 4 illustrating an exemplary structure of a gripping portion on both sides and edges of the belt;

FIG. 11 is schematic flow chart showing an exemplary method for forming a belt for reducing the appearance of cellulite; and

FIG. 12 is a schematic flow chart showing an exemplary method for reducing the appearance of cellulite in human skin.

### DETAILED DESCRIPTION OF THE PREFERRED EMBODIMENT

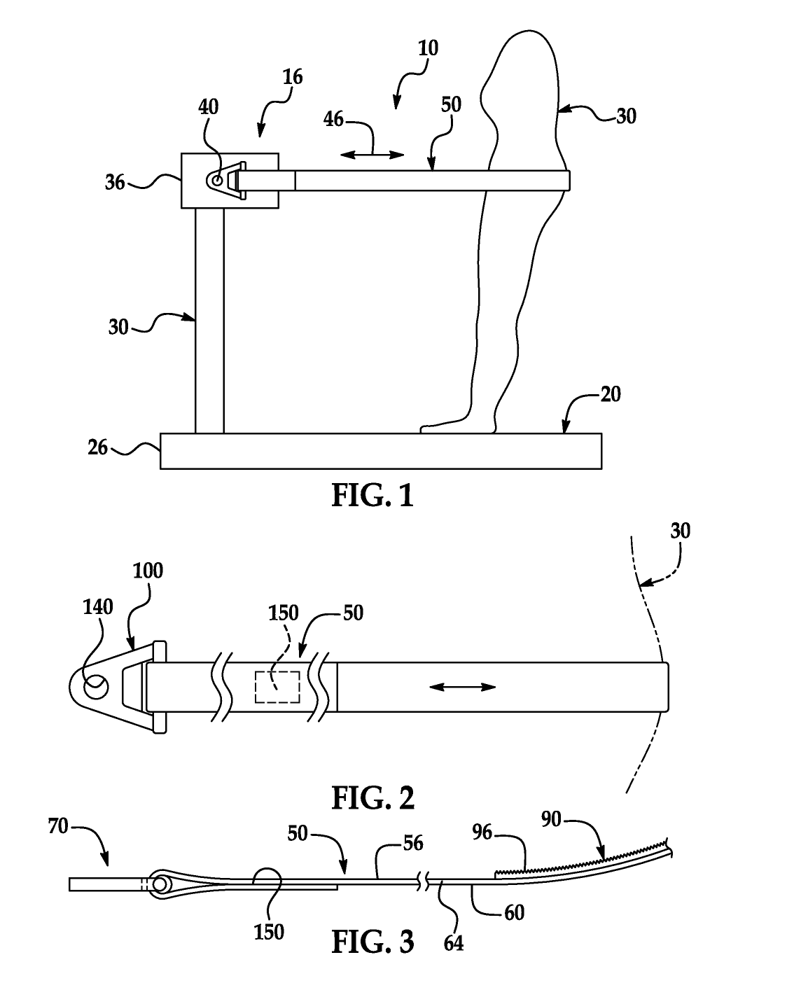

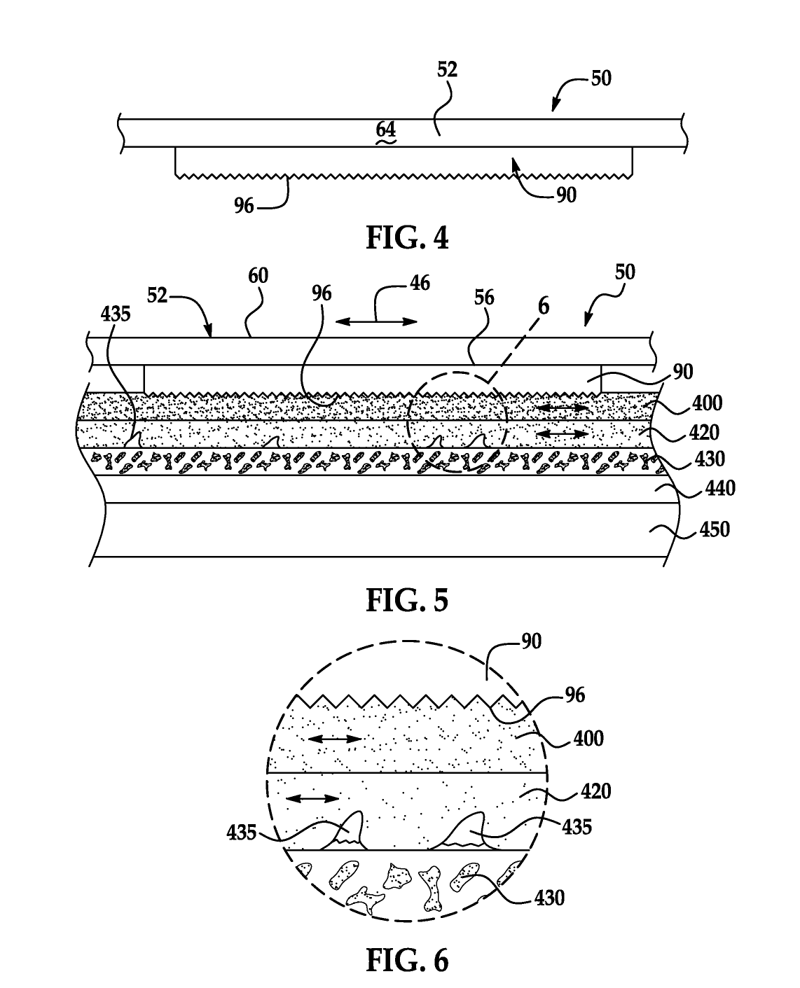

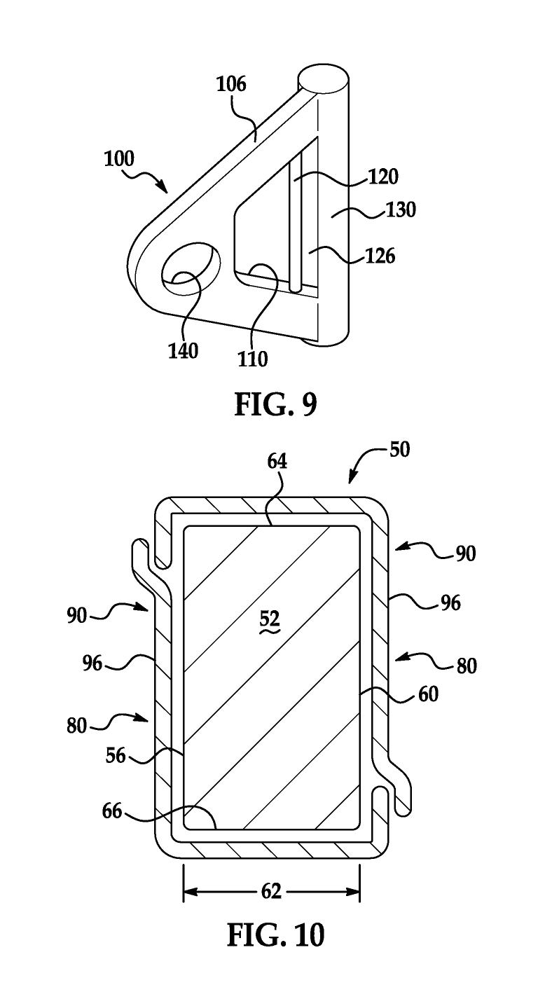

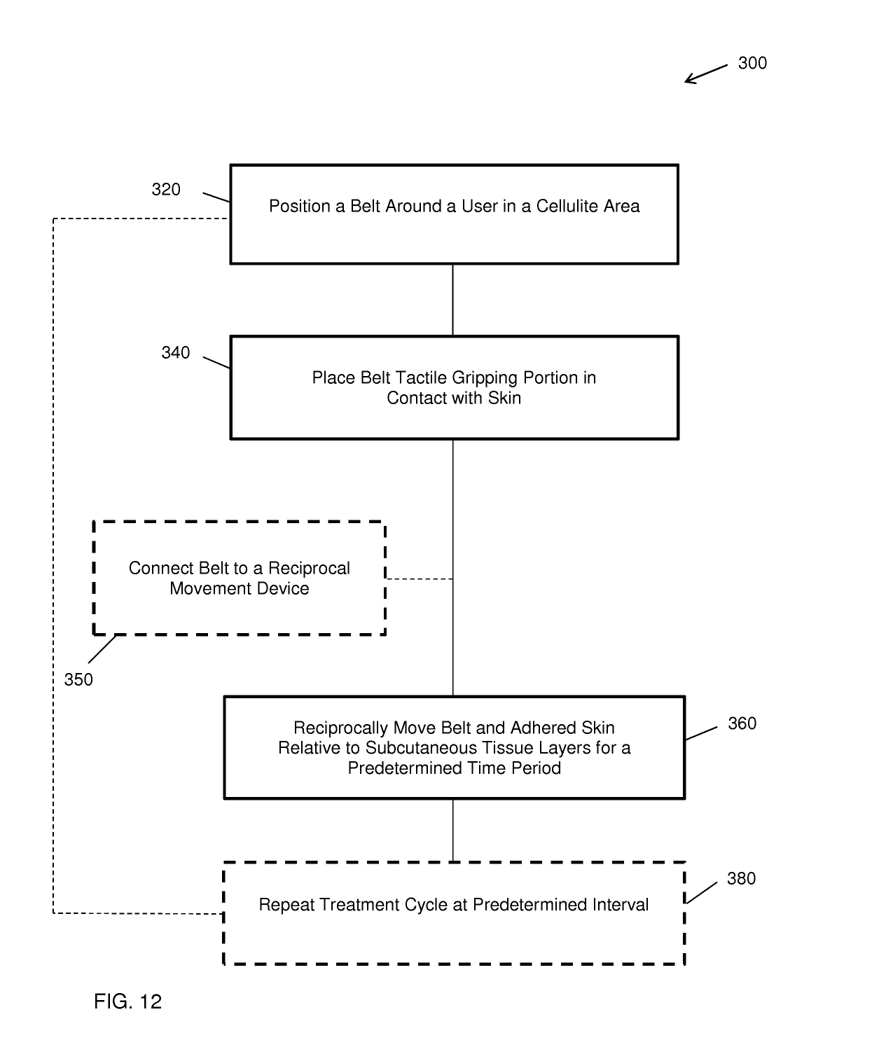

Examples of an inventive cellulite appearance reduction device 10 and methods 200 are illustrated in FIGS. 1-12. The exemplary device and methods as further explained below are, in one example, intended for use with commercially available reciprocating vibratory massage machines 16 seen generally in FIG. 1. Referring to FIG. 1, an exemplary massage machine 16 useful with the invention 10 generally includes a platform 20 including a forward end 26 and an upstanding post 30 as generally shown. In the example shown, the vibratory machine includes a reciprocation or vibratory generator head 36. The head 36 includes opposing members 40 on opposing sides of the head 36 which generate a reciprocating or back-and-forth, generally linear movement or stroke length 46 at the opposing members 40 which serve as connection points for an inventive belt described below. An example of a suitable massage machine 16 is the Six Speed Beauty Massager sold by ib3 Health. Other similar devices known by those skilled in the art may be used.

Referring to FIGS. 1-10, examples of a cellulite reduction belt 50 are illustrated. An exemplary method for reduction of cellulite includes use of the belt 50 with the exemplary vibratory massage device 16 described above. Referring to FIGS. 2-9 one example of belt 50 for use with an exemplary connector 100 for connection of the belt 50 to the massage device 16 is illustrated.

Referring to FIGS. 2, 3 and 7, exemplary belt 50 is a wide, thin belt or strap 52 including a first side 56, an opposing second side 60 defining a belt thickness 62 and edges 64 and 66. Belt 50 terminates and opposing ends 70 and 76. In the example shown, belt 50 includes a gripping portion 80 positioned on the strap 52 first side 56 between the ends 70 and 76 as generally shown. Belt strap 52 may be formed of natural materials, for example leather, or of woven, extruded molded or other processed nylon, textiles, polymers, elastomers or other natural or manufactured materials suitable for the particular application. In one example, a suitable belt strap 52 is four (4) inches wide, one-sixteenth ( 1/16) of an inch thick formed from heavy-duty woven polypropylene or nylon. Other sizes and configurations of belt straps 52 known by those skilled in the art may be used.

In the illustrated example, gripping portion 80 is defined by a film 90 adhered to the belt inner surface 56. In a preferred example, film 90 is a substantially non-slip, gripping layer or contact surface 96 having a tactile or sticky quality. At least part of the gripping portion 80 and contact surface 96 is intended to directly contact the user's skin in the area where cellulite is desired to be reduced. Gripping portion 80 and contact surface 96 having the above features and characteristics may come in many forms and materials. In one example, film 90 is a thin, extruded or molded material sold under the trade name Dycem manufactured by Dycem Limited which is securely attached belt inner surface 56 as best seen in FIGS. 3, 4 and 7. The exemplary film 90 of Dycem material is secured to belt strap 52 through adhesive applied to one side of the film 90 and inner surface 56. Other methods of securing film 90 to strap 52 known by those skilled in the art may be used.

The exemplary film 90 Dycem material is a thin, pliable, flexible material that has a slight cushioning property and exhibits a tactile or slightly sticky surface which gently “grips” or sticks to clean human skin when placed in contact and put under mild pressure. Other suitable materials having these qualities and characteristics known by those skilled in the art may be used. Suitable materials would also preferably exhibit qualities of being easily removed from contact with the skin without discomfort to the user, are easily cleaned and sanitized, are suitable and durable under high frequency reciprocal and/or vibratory movement when in contact with skin, may be securely attached or integrated with belt strap 52 in efficient manufacturing processes and are of relatively low cost. In the example illustrated in FIG. 2-9, the film 90 is applied to only one side of the strap 52 inner surface 56 and does not extend beyond, or wrap around edges 64 or 66.

In an alternate example of belt 50 shown in FIG. 10, belt 50 includes gripping portions 80 and contact surfaces 96 on both of the inner 56 and outer 60 surfaces of strap 52. Using the exemplary film 90 forming the gripping portion 80 described above, film 90 is secured to both sides of belt 50 and wraps around edges 64 and 66 as generally shown. Film 90 is secured to strap 52 in the manner described above (spaces between films 90 and strap 52 shown for convenience of illustration only). When secured film 90 is rigidly secured to strap 52 allowing no relative movement between films 90 and strap 52. It is understood that other orientations and methods of securing film 90 to strap 52, for example the areas of overlap of the two films 90, known by those skilled in the art may be used. In the enlarged cross-section shown in FIG. 10, despite the areas of double-thickness of film 90, contact surfaces 96 are substantially flat and free from raised edges which may disrupt the “grip” or tactile portion 80 and contact with a user's skin or otherwise cause an area of irritation or undue friction. In a preferred example, gripping or contacting surface 96 may be relatively smooth or may have a texture depending on the application and performance requirements of the condition to be treated or preferences of the user.

In alternate examples of belt 50 not illustrated, it is understood that grip portion 80 may be formed from other materials and/or manufacturing processes. Referring to FIG. 10, it is understood that forming a gripping portion 80 on both sides 56 and 60 can be achieved through a single piece of film 90 wrapped around the circumference of the belt and adhered back on itself reducing the exposed edges or seams. It is contemplated that strap 50 could be dipped, coated or molded with a material fully covering the sides 56 and 60 and edges 64 and 66. If is further contemplated that strap 56 could be formed through impregnating or integrating a suitable material in the belt material itself or into the woven structure to provide a suitable gripping portion 80 having the tactile, skin gripping and other characteristics described above.

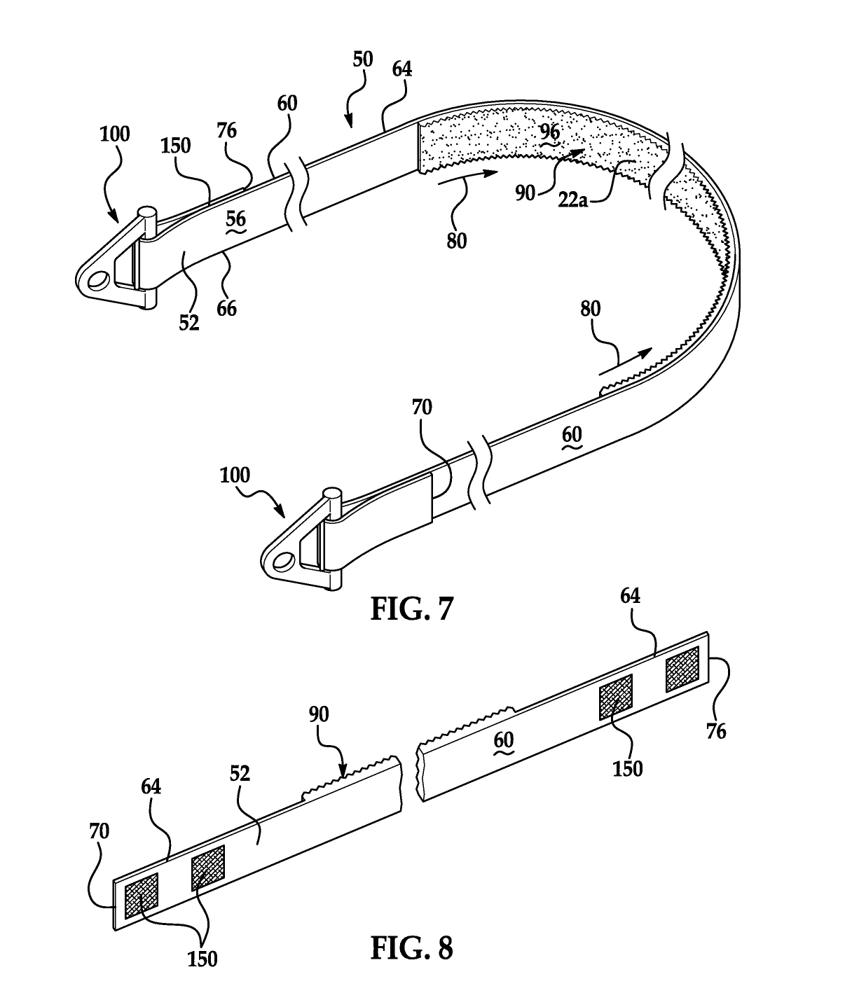

In another example, strap 50 may be manufactured from a material that exhibits the qualities and characteristics described above without separate films or coatings. Other materials, methods and processes to achieve the characteristics and qualities of belt 50 and gripping portion 80 described above known by those skilled in the art may be used. Further, although the gripping portion 80 shown in the FIG. 7 example is shown covering only a portion of the strap 52 length between the connectors 100, it is understood that the gripping portion can extend along a greater length, for example the entire belt between the connectors 100, or a lesser length of strap 52 than shown in FIG. 7. It is further contemplated that the gripping portion may not be substantially centered on the strap 52 length as illustrated and may comprise multiple gripping portions separated along belt strap 52 (not illustrated). Other locations and orientations of gripping portion 80 along strap 52 may be used to suit the application and as known by those skilled in the art.

Referring to FIGS. 2, 3 and 7-9 an example of connectors 100 used to quickly attach belt 50 to reciprocating massage device 16 is illustrated. In a preferred example, connector 100 is universal, compatible and easily engaged with the opposing members 40 of many commercial massage devices. Alternately, different connectors 100 could be included or offered with belt 50 to achieve ease of use on many commercial devices.

In the example connector 100 illustrated, connector 100 is generally shown in a D-ring configuration and includes a plate 106 defining an opening 110. Plate 106 further includes a cinch bar 120 defining a belt opening 126 and a post 130 as generally shown. In the example, connector 100 includes a drive opening 140, preferably serving as a universal opening or connection point for engagement of the connectors 100 and belt 50 to opposing members 40 of the massage device 16 as best seen in FIG. 1.

In example illustrated, connectors 100 are securely, but removably connected to strap 52 adjacent the ends 70 and 76. In one example of use with exemplary connector 100, strap 52 includes connection pads 150 secured to the belt and spaced apart along strap 52 as generally shown. In a preferred example, pads 150 are VELCRO-type hook and loop or other secure, but easily connectable and removable devices. Each end 70 and 76 of strap 52 is passed through the belt opening 126 between post 130 and cinch bar 120 of a respective connector 100. As best seen in FIGS. 2 and 8, the respective ends 70 or 76 are double-backed and the respective pads 150 of the respective end of the strap are aligned and engaged with one another to define a loop passing through and mounting the respective connector 100 to strap 52. With connectors 100 securely fastened to strap 52, belt 50 can be connected to massage device 16 as described above.

Although shown generally as a D-shaped plate, it is understood that connectors 100 can take many other forms, structures, geometries and orientations, or and may be secured to strap 52 in many other ways, as known by those skilled in the art. For example, connectors 100 may include a pin or hook (not shown) which connects to coordinating members 40 of the massage device 16 to securely and effectively transfer the reciprocating and/or vibratory motion of the device 16 to the belt 50.

Further, other structures, geometries and methods for securing strap 52 to connector 100 may be used. For example, belt ends 70 and 76 may have a direct mechanical or friction-type connection to a portion of connector 100 instead of the illustrated single loop-through design. In such an instance, other structures and means may be used to adjust the length of the belt to suit the application or user. Other structures and configurations for attaching belt 22 back in itself other than hook and loop-type pads 150 may be used to accommodate very heavy individuals, for example dual D-shaped cinch rings where the belt ends 70 and 76 are looped through and pulled or cinched tight. It is contemplated that where the grip portions 80 are of long duration or are replaceable, the attachment of strap 52 to connectors 100 can be permanent through heavy duty stitching, mechanical fasteners or other devices and methods known by those skilled in the art. Although described as a universal connector 100, two or more different connectors could be packaged with the exemplary belt 50 and the appropriate connectors for a user's massage device 16 may be used. Alternately, where the belt 50 is used with a device other than massage device 16, other connectors 100 or devices suitable for those applications may be used without deviating from the present invention.

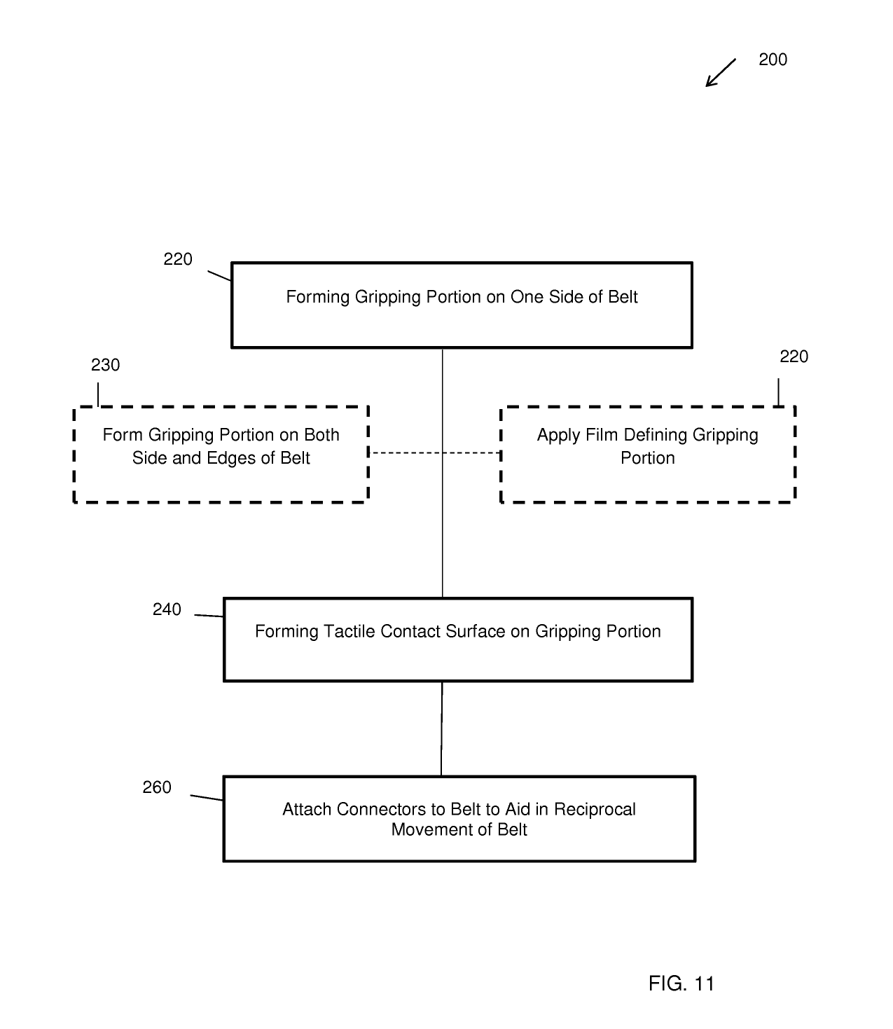

Referring to FIG. 11, an exemplary method for forming a belt for use in reducing the appearance of cellulite on human skin 200 is illustrated. In the exemplary method, in step 220 a gripping portion 80 is formed on an elongate belt strap 52 described in detail above.

In step 240, a tactile contact surface 96 is formed on at least a portion of the gripping portion. The gripping portion 80 and contact surface may be formed in many ways or methods described above which produce a durable tactile or slightly sticky surface which mildly sticks or grips the skin preventing all, or substantially all, relative movement between a user's outer skin and the contact surface 96 of the gripping portion.

In an alternate step 230, the gripping portion can be formed on both sides 56 and 60 of the belt strap 52 as well as the edges 64 and 66 as described in detail above.

In an alternate step 235, the gripping portion and contact surface can be defined by a film 90 that is attached to the belt strap as described above.

In exemplary method step 240, connectors 100 are attached to the belt which aid in the belt being reciprocally moved in the manner described above. These connectors may be for use with commercial reciprocal machines or simpler reciprocal means, for example, handles for pulling by the user or an assistant.

Referring to FIGS. 12 and 5 and 6, an exemplary method for reducing cellulite appearance in human skin 300 is illustrated. In the example, step 320 includes placing the belt strap 52 partially around a selected area of a user 30 where cellulite is desired to be reduced, for example in the buttocks or thigh as generally shown in FIG. 1.

In step 340, and as best seen in FIGS. 5 and 6, the strap 52 gripping portion 80 contact surface 96 is preferably placed in direct contact with the naked, outer layer epidermis 300 through mild contact pressure. The gripping portion 80 tactile or generally non-slip surface 96 functions to physically “grip” or mildly stick to the epidermis or outer skin layer 26.

In an optional, but preferred step 350, the belt 50 is oriented and connected to a vibratory or reciprocal massage device through connectors 100 as generally described above. In a most simplistic example, hand handles could be used instead of connecting belt 50 to a commercial reciprocation device.

In step 360, in a preferred method having belt 50 connected to a vibratory or reciprocal device 16, device 16 imparts a selectable amount of reciprocal, linear, back-and-forth movement in a direction and along a stroke length 46 to the belt 50 at a high frequency. For example, the linear back-and-forth movement or stroke length 46 that belt 50 moves may range from one (1) centimeter (cm) to four (4) centimeters (cm) for every 360 degree revolution of opposing member 40 of device 16 about an axis of rotation in head 36. In an exemplary device 16, the frequency of opposing members 40 may range from several hundred revolutions per minute (RPMs) to 7600 RPMs or more. Different stroke lengths 46 and frequency of the stroke length or RPMs of device 16 may extend outside this range without deviating from the present invention. In one example, it has been determined that setting of a stroke length 46 of two (2.0) centimeters at a frequency of 530 RPM is suitable for treatment of cellulite in a healthy, middle aged, relatively fit, user 30.

In exemplary method step 360, the preferably high frequency reciprocal movement of the device 16 and belt 50 is imparted to the user's outer skin layers, the epidermis layer remaining in gripping, substantially non-relative moving contact with the gripping portion contact surface 96 of belt strap 52. As the belt 50 is reciprocated and/or vibrated by the massage machine 16, the gripped epidermis skin layer 400 along with the inner dermis skin layer 420 is pulled at a selected high frequency relative to the subcutaneous tissue layers 430 (only one layer shown for ease of illustration) between the fascia 440 and muscle 450 layers for a predetermined time or treatment period. This causes a high frequency pulling and “tearing” relative motion action or effect on the fat cell/collagen projections 435 that extend from the subcutaneous tissue layer 430 into the dermis 420 as generally shown. This relative movement of the gripped epidermis 400 and dermis 420 relative to the subcutaneous layer 430 disrupts, tears and/or severs a plurality of fat cell/collagen projections 435 extending between the layers that are forcibly being moved relative to one another. This disruption, stretching, tearing and/or severing of the fat cell/collagen projections 435 has the effect of reducing the visual appearance of cellulite on the epidermis 400 desirable by many health and appearance conscious persons.

In one example, a continuous treatment period using device 16 and belt 50 of 15-30 minutes has been found suitable. Other treatment duration periods beyond this range may be used as known by those skilled in the art and that are found suitable for particular users, the device 16 employed or other equipment used or conditions of the users.

In method step 380, the treatment described above is repeated on a predetermined or variable interval, for example every other day, twice a week or other interval that is found useful to the user to achieve the reduction of cellulite appearance or tone desired, or as recommended by a medical professional. It is understood that additional or fewer method steps, and in a different order, may be used to achieve the above described objectives may be used without deviating from the present invention.

The described and illustrated inventive devices and methods of employing belt 50 in a method of gripping, pulling, stretching and/or tearing action of the skin in the manner described is in contrast to the action of conventional massage machine belts wherein the belt slides back and forth over the skin and there is no significant relative movement between the outer skin layers and the subcutaneous tissue layers. The inventive belt 50 and methods imparting the relative movement of the outer skin layers relative to the subcutaneous layers has the effect of tearing, breaking up, disrupting or otherwise dissipating the fatty subcutaneous layer deposits and projections into the upper/outer layers of the skin to effectively reduce and/or eliminate the appearance of cellulite.

While the invention has been described in connection with what is presently considered to be the most practical and preferred examples, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method of reducing cellulite appearance in human skin, the method comprising the steps of:
positioning an elongate belt having a length partially around and in contact with a human user in an area exhibiting a cellulite appearance where a reduction in cellulite appearance is desired;
reciprocally moving the belt to move the outer skin layers relative to an underlying subcutaneous tissue layers; and
disrupting adhesions of at least one of subcutaneous fat or collagen extending between the subcutaneous tissue layers and the outer skin layers thereby reducing the cellulite appearance.

2. The method of claim 1 further comprising the steps of:
placing a tacky contact surface of a gripping portion of the belt in direct contact with the human user's outer skin layer in the cellulite appearance area; and
removably adhering the belt contact surface directly to the outer skin layer preventing substantial relative movement between the belt and the adhered outer skin layer.

3. The method of claim 2 wherein the step of reciprocally moving the belt further comprises moving the belt along the length of the belt through a predetermined stroke length and at a predetermined frequency.

4. The method of claim 2 wherein the step of disrupting adhesions further comprises at least one of stretching or tearing subcutaneous fat or collagen extending between the subcutaneous tissue layers and the outer skin layers.

5. The method of claim 2 wherein the step of reciprocally moving the belt further comprises a duration of between about 15 and 30 minutes.

6. A method of reducing cellulite appearance in human skin, the method comprising the steps of:
positioning an elongate belt having a length partially around a human user in an area exhibiting a cellulite appearance where a reduction in cellulite appearance is desired;
placing a tacky contact surface of a gripping portion of the belt in direct contact with the human user's epidermis skin layer in the cellulite appearance area;
removably adhering the belt tacky contact surface directly to the human user's epidermis skin layer preventing substantial relative movement between the belt and the adhered epidermis skin layer; and
reciprocally moving the belt through a stroke length and at a frequency to move the adhered to epidermis skin later and inner dermis skin layer relative to an underlying subcutaneous tissue layers; and
disrupting at least one of subcutaneous fat or collagen extending between and the subcutaneous tissue layers and the inner dermis skin layer thereby reducing the cellulite appearance.

7. The method of claim 6 wherein the step of disrupting comprises stretching of the at least one of subcutaneous fat or collagen projections extending between the subcutaneous tissue layers and the inner dermis skin layer.

8. The method of claim 6 wherein disrupting adhesions comprises stretching of the at least one subcutaneous fat or collagen projections connecting the subcutaneous skin layers to the inner dermis skin layer.

9. The method of claim 6 wherein step of disrupting adhesions comprises at least one of tearing or severing subcutaneous fat or collagen protections extending between the subcutaneous tissue layers and the inner dermis skin layers thereby reducing the cellulite appearance.

10. The method of claim 6 further comprising the step of attaching a connector adjacent to respective ends of the belt, the connectors adaptable to engage a reciprocating moving device.

11. The method of claim 10 further comprising the step of connecting the belt to a reciprocating moving device, the reciprocating device reciprocatingly moving the belt through the stroke length and at the frequency.

12. The method of claim 6 wherein the stroke length is along the length of the belt and is between about 0.5 centimeters (cm) and about 4.0 centimeters.

13. The method of claim 6 wherein the frequency of completion of the stroke length is between 500 and 600 strokes lengths per minute.

14. The method of claim 6 further comprising the step of continuously reciprocally moving the belt for a duration of about 15 to 30 minutes.

15. The method of claim 14 wherein the duration is repeated a plurality of times at a predetermined interval.
